(19) United States
(12) Patent Application Publication
(10) Pub. No.: US 2005/0216716 A1
(43) Pub. Date: Sep. 29, 2005

(54) System and method for licensing and distribution of I/O in partitioned computer systems

(76) Inventors: Philip M. Hoffman, Oreland, PA (US); Todd Little, King of Prussia, PA (US); Jessica Paragas, Springfield, PA (US); William Stratton, Malvern, PA (US); James W. Thompson, West Chester, PA (US); Steven E. Clarke, Newtown Square, PA (US)

Correspondence Address: Attn: Michael B. Atlass;Unisys Corporation, Unisys Way, MS/E8-114, Blue Bell, PA, 19424-0001, US

(21) Appl. No.: 10/894,939

(22) Filed: Jul. 20, 2004

Related U.S. Application Data
(60) Provisional application No. 60/557,216, filed on Mar. 29, 2004.

(51) Int. Cl. G06F 9/00; H04L 9/32; G06F 11/30; G06F 12/14; G06F 9/24; G06F 15/177

(52) U.S. Cl. 713/1; 713/189

(57) ABSTRACT

A method and system for a partitioned computer system includes the allocation and limiting of input/output (I/O) resources. The method involves reading an I/O key that allocates a system-wide upper limit on I/O resources. The limit may be divided by the number of active partitions within the computer system. Each partition may then be given an equal share of the available I/O resources. If any one partition exceeds the share of resources for that partition, the I/O resource use is capped to meet the maximum limit for that partition. A user may enter the system to customize the initially uniform distribution of I/O resource within the partitioned computer system. Additional partitions may be added or deleted to the computer system. The addition of a partition permits a dynamic reallocation of I/O resource so that a new partition may have a minimal I/O resource allocation for initial operation.

### CROSS REFERENCE TO OTHER APPLICATIONS

The patent is based on and claims priority from a provisionally filed U.S. Patent Application Ser. No. 60/557,216 filed on Mar. 29, 2004.

The following co-pending application has subject matter in common with the current application:

Patent application Ser. No. 09/676,162 filed Sep. 29, 2000 entitled “Authorization Key System for Selectively Controlling the Performance of a Data Processing System”, attorney docket number RA-5311, which is incorporated herein in its entirety.

### FIELD OF THE INVENTION

The current invention relates generally to data processing systems, and more particularly to methods for the licensing and distribution of I/O functions within a computer system.

### BACKGROUND OF THE INVENTION

Many businesses are challenged with ensuring that their data processing systems keep pace with expanding and peak demands. As a result, data processing systems have been developed that have adaptable performance mechanisms for providing additional performance when needed. Commonly-assigned U.S. patent application entitled “Authorization Key System for Selectively Controlling the Performance of a Data Processing System”, Ser. No. 09/676,162 which is incorporated herein by reference in its entirety, discloses an exemplary system employing processor keys to assist in the adaptation of system resources to user needs.

Other adaptive data processing systems have been developed that utilize hardware and software elements constructed to accommodate a partitioning of a computer system for multiple user purposes. A partitioned system may be established as a result of a contract for computer services between a business user and a computer supplier. A partition is a grouping of resources that are allocated to execute in a cooperative manner to perform one or more assigned tasks. Each partition determined in the contract may specify an instruction processor (IP) performance level so that a business user can apply the partition to computing tasks that his business needs to perform.

For example, a partition may be formed that includes one or more predetermined instruction processors (IPs) and Input/Output Processors (IOPs), and a predetermined amount of memory within a shared main memory. A second partition may be created to include different processors, IPs and IOPs, and another memory range. Each of these partitions may operate independently from the other, each partition having its own operating system instance, so that a number of tasks may be executed in parallel within the system. When a system needs to be changed to adapt to a changing business requirement, the partitions can be redefined. For instance, if needed, processing resources may be allocated to the same partition and assigned to execute a single high-priority task.

Just as additional processors may be employed to adapt to a changing business requirement by engaging additional processors, so too can memory be expanded in a partition. Current systems may be constrained by other partition resources which are not yet expandable. It may be desirable for input/output (I/O) functions to be expanded as well as processor and memory capacity in order to meet a changing customer need. Additionally, the utilization of such an expanded partition resource may be a source of revenue for computer supplier if additional resources are needed by a user. Typically, an I/O expansion has been accomplished by adding additional modules or cards containing I/O channel capacity to a computer system. There is currently no built-in mechanism for the expansion of I/O resources within a partitioned computer system which can provide the system user with access and control of more I/O resources and the computer system supplier with more revenue.

Thus, there is a need for a mechanism in partitioned computer systems to provide additional I/O resources which are easily expandable to meet system user needs. The present invention addresses the aforementioned needs and solves them with additional advantages as expressed herein.

### SUMMARY OF THE INVENTION

A method of providing an allocation of input/output (I/O) resources to a partitioned computer system involves identifying if the system is to be an I/O limiting system or an I/O licensing system. If the system is an I/O limiting system, a fixed amount of I/O resource is allocated to each active partition within the system. If the system is to be an I/O licensing system, an I/O key is read, and this allocates a system-wide maximum limit of I/O resources. The system wide resource may be evenly divided among the active partitions and each partition may use the divided portion assigned to each partition.

In one embodiment, a user may enter into a partition and raise or lower the amount of I/O resource that a partition uses in order to customize the system performance. Additional allocation for a particular partition may be provided if there is unallocated I/O resources available within the system. The user may decrease the allocation of I/O resources of other partitions in order to generate unallocated resources for another partition to use.

In one embodiment, a dynamic allocation may occur when a new partition is added to the computer system under the condition where there are no unallocated I/O resources. In this instance, a dynamic allocation may occur where some partitions may have their I/O allocations reduced to generate unallocated I/O resources for the new partition. The new partition may thus be able to come on-line with a sufficient amount of I/O resources available for basic operations. A system user may then balance the partition-to-partition allocations to optimize the system.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary system that may employ the current invention;

FIG. 2 is a flow diagram addressing an I/O resource distribution scheme employed in an embodiment of the invention;

FIG. 3 is a flow diagram addressing a further aspect of FIG. 2; and

FIGS. 4A and 4B are block diagrams depicting a dynamic reallocation aspect of an embodiment of the current invention.

### DETAILED DESCRIPTION OF ILLUSTRATIVE EMBODIMENTS

Partitioned Computer Environment

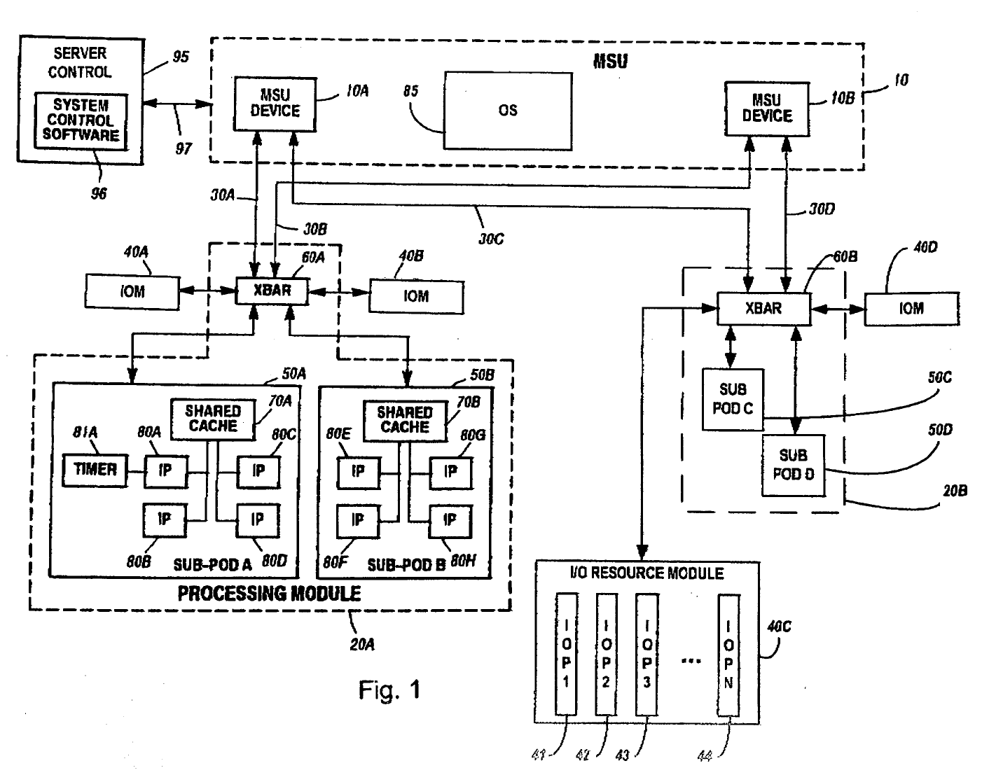

FIG. 1 is a block diagram of an exemplary partitioned computer system that may employ the current invention. This partitioned computer system includes a Memory Storage Unit (MSU) 10 (shown dashed) which provides the main memory facility for the system. The MSU includes one or more MSU devices individually shown as MSU 10A and MSU 10B, which each contains a predetermined portion of the memory space of the system. Many more MSU devices may be included within a full configuration.

The system further includes processing modules (PODs) 20A and 20B. A POD provides the processing capability for partitions within the computer system. A greater or lesser number of PODs may be included in the system than are shown in FIG. 1. In one embodiment, up to four PODs are included in a fully populated system.

Each of the PODs is coupled to each of the MSU devices via a dedicated, point-to-point connection referred to as an MSU Interface (MI), individually shown as MIs 30A through 30D. For example, MI 30A interfaces POD 20A to MSU device 10A, and MI 30B interfaces POD 20A to MSU 10B device. Other MI units are similarly interfaced to other PODs.

Each POD includes two sub-processing modules (Sub-PODs) and a crossbar module (XBAR). For example, POD 20A includes sub-PODs 50A and 50B and XBAR 60A. Other PODS and XBARS are similarly configured. Each sub-POD is interconnected to the respective crossbar module (XBAR) through a dedicated point-to-point interface.

The system of FIG. 1 may further include input/output resource modules (IOMs) individually shown as IOMs 40A through 40D. The input/output modules provide the interface between various communications links and a respective one of the PODs 20. Each IOM is coupled to a POD via the POD's XBAR. For example, I/O 40A is coupled to XBAR 60A. XBAR 60A buffers data for the respective sub-PODs 50A and 50B and IOM 40A and 40B and functions as a switch to route data between any of these sub-PODs and IOMs to an addressed one of the MSU devices 10A and 10B. The input/output resource modules 40A, B and C contain input/output processors (IOPs) 41, 42, 43 and 44. Each IOP preferably contains multiple I/O channels, each channel being capable of transfer rate control via the local IOP.

In the exemplary system of FIG. 1, each sub-POD includes a shared cache and one or more Instruction Processors (IPs). For example, sub-POD 50A includes shared cache 70A and IPs 80A-80D. Other sub-PODs are similarly configured. In one embodiment, a sub-POD 50 may include between one and four IPs 80. Each IP may include one or more dedicated caches and interface logic for coupling to the interface with the shared cache. The shared cache stores data for each of the IPs within its sub-POD. Finally, each IP includes a quantum timer shown as timer 81A for IP 80A. This timer has many uses, including the facilitation of multi-tasking for the respective IP.

The system of FIG. 1 includes at least one instance of an Operating System (OS) that is loaded into MSU 10 to control the system. OS 85 is shown generally occupying memory included within MSU 10, and it will be understood the selected memory range in which OS 85 resides will actually be provided by one of MSU devices 10A or 10B.

Finally, the system of FIG. 1 includes a system server 95, which may be a workstation, personal computer, or some other processing system executing system control software 96. This system server 95 is coupled to the other units in the system via a scan interface 97. Although for simplicity, the scan interface is shown coupled solely to MSU 10, it will be understood it is coupled to the other units in the system as well. System server 95 provides all initialization, maintenance, and recovery operations for the system via the scan interface. In addition, system server 95 may be employed by an operator to perform configuration activities.

The architecture of FIG. 1 may be utilized to construct a system of multiple partitions within a data processing system. It will be appreciated that the system of FIG. 1 is merely provided as an example computing environment in which the present invention may operate. Any other data processing system having any other type of configuration may usefully employ the inventive system and method to be discussed in the following paragraphs. With the foregoing available for discussion purposes, the current invention is described in regards to the remaining drawings.

Processor and I/O Keys

A partition is a grouping of resources that are allocated to execute in a cooperative manner to perform one or more assigned tasks. A partitioned computer system provides that each partition has processor, memory and I/O resources. The system manufacturer provides a key to the system user so that specific partition resources are made available to the system user. Computing performance in partitioned computer systems may be determined by the use of a processor key. A processor key enables functionality within a partition and may establish processor performance limits within the partition. Generally, there may be one processor key per established partition. The processor key for the partition defines baseline and ceiling processor performance parameters, expiration date and a maximum time of use for the identified partition. Patent application Ser. No. 09/676,162 entitled “Authorization Key System for Selectively Controlling the Performance of a Data Processing System” discloses the use of processor keys and is incorporated herein by reference.

A processor key may be modified to indicate that an I/O key is needed to establish I/O performance for a given partition. For example, a processor key may have two bits; one which specifies if the system is an I/O limiting system and one bit which specifies if the system is to be an I/O licensing system. An internal format example embodiment of a processor key requiring the use of an I/O key may encode the following data in 256 bits as shown in Table 1:

TABLE 1
Processor Key Format

| Data | Description | Bits |
|---|---|---|
| Type | Type of Key | 4 |
| | 1 = permanent processor key | |
| | 2 = temporary processor key | |
| Version | Value = 5 | 4 |
| Images | Number of partition image licenses | 4 |
| MCN | Manufacturing Control Number (unique for each system) | 20 |
| Days | Number of days that a temporary key can be active | 10 |
| DR | Disaster Recovery = 1 | 1 |
| Reporting Day | Reporting day of month for metered utilization | 5 |
| | 0 = normal CoD | |
| | 1-31 = metered utilization management | |
| Record Interval | CoD special purpose | 6 |
| | 61 = Clear All key | |
| | 62 = SAMM percentage test key | |
| | 63 = SAMM performance level test key | |
| | Metering recording interval in minutes (value = 1 to 60) | |
| Meter Mode | Mode of Metering Key | 3 |
| | 0 = Credit Mode | |
| | 1 = Non-Credit Mode | |
| | 2 = Profile Mode | |
| Report Interval | Automatic sending of report interval | 3 |
| | 0 = monthly | |
| | 1 = daily | |
| | 2 = 8 hours | |
| | 3 = 4 hours | |
| | 4 = 2 hours | |
| | 5 = hourly | |
| Regulate RPM | Regulate RPM = 1 | 1 |
| Recover IPs | Recover IPs = 1 | 1 |
| Mem Licensing | Memory licensing required = 1 | 1 |
| IO Licensing | IO licensing required = 1 | 1 |
| IO Limiting | IO Limit of 30,000 Ios/Sec to be Enforced = 1 | 1 |
| Expiration | Key expiration (or 0) in Posix time DIV (24 * 60 * 60) format | 16 |
| Machine ID | 8 bit WATI machine type + 8 bit type modifier | 16 |
| Unique Key ID | Key creation Posix time (seconds since Midnight 1/1/1970); | 32 |
| | Unique Key ID used to mark use and prevent reuse of temporary | |
| | keys | |
| Partition Image | License image information for up to 4 partitions | 4 * 16 |

| | | |
|---|---|---|
| Descriptions | Redundant | 1 bit |
| | Price Point | 4 bits |
| | IP Performance Level | 6 bits |
| | Number of IPs-1 | 5 bits |

| | | |
|---|---|---|
| Partition Image | Ceiling RPM value (CoD) or base RPM value (metering) for up | 4 * 16 |
| Ceiling or Base | to 4 partitions. Each RPM value is associated with the | |
| | corresponding partition image descriptor. | |
| Totals | | 256 |

The processor key in Table 1 is compatible with an instruction processor (IP) licensing scheme as in reference patent application Ser. No. 09/676,162 filed Sep. 29, 2000 entitled “Authorization Key System for Selectively Controlling the Performance of a Data Processing System”. Consequently, the functions of the Table 1 data fields such as type, version, images, reporting features, identifiers, and image descriptions may be specific to the licensing of IPs within a partitioned computer system. In addition, the processor key of Table 1 supports the use of memory and I/O licensing.

Notable fields placed in the processor key of Table 1 are the memory licensing field and the two I/O related fields. Memory licensing may be an option on a partitioned computer system. The exemplary processor key of Table 1 also provides an indication as to the necessity of a memory licensing key in the system. The I/O fields of I/O licensing and I/O limiting provide direct support for I/O features within a partitioned system using a processor key.

Since a processor key may be read first in a partitioned computer system, the processor key can provide the first indication to a computer system that an I/O key is needed to authorize the use of I/O resources. The processor key of Table 1 also shows an I/O licensing field which indicates whether an I/O licensing key is required. The I/O limiting bit field of Table 1 may be used to indicate that the key is to be used in an I/O limiting system. Normally, either the I/O licensing bit is set or the I/O limiting bit is set, but not both. These I/O indicators are generally in accordance with a contract between the system user and the system provider. It is assumed that a computer system is provided to a system user with more I/O capability than that which the user may currently need to allow growth in I/O use, if desired by the user.

If the system is an I/O limiting system, then no I/O key is needed to configure the I/O of the system. In this instance, the processor key is examined by a software support module (IP1SUPPORT) running on an instruction processor (IP) in association with an operating system. The I/O software support module is a program that contains an object library that manages licensing aspects of the present invention. An example operating system is the Master Control Program (MCP) available from Unisys® Corporation. If a processor key indicates that a system is to be of the I/O limiting type then a fixed maximum I/O rate is fixed per partition of the system. For example, if the I/O limit set on an I/O limiting system is 30K I/O, then each active partition may have a maximum of 30K I/O per unit time (a second) and no further allocation may be granted.

If an installed processor key indicates that the system requires an I/O license, then a different process may be expected. Under the condition where a system is to be governed by an I/O key license, but no I/O key is available, the I/O software support (IP1SUPPORT) program running in the operating system in a partition can sense the absence of the I/O key. The I/O license software support (IP1SUPPORT) may then establish a restricted limit on the I/O resource on a per partition basis. For example, in a I/O licensing system where no I/O key is yet installed, an I/O limit of 5K I/O may be placed on all partitions. This limitation is communicated to the system support software 96 where it is available in shared memory for any IP to read. Until a valid I/O key is installed, no further I/O capability may be granted.

In one embodiment, an I/O key may be an encrypted field that is input to the system control software 96 of FIG. 1. In one embodiment, the external format, or encrypted format of an I/O key is as follows:
IO1-<52 characters>:<10 digit password>.

The <52 characters> are encrypted/decrypted using a modified data encryption standard. Decrypted data is 256 bits (32 bytes). In one embodiment, the system server 96 having a software application for I/O licensing support called IP1SUPPORT can decode the <52 characters>. An example external (encrypted) I/O key may be as follows:

Where the IO1 prefix identifies the key as an I/O key as opposed to a processor key which may have an IP1 prefix. The system licensing support software (IP1SUPPORT) may then decrypt the I/O key such that an internal or decrypted format of the external I/O key results.

The internal format of an I/O key encodes the following data in 256 bits as shown in Table 2:

TABLE 2
Input/Output (I/O) Key

| Data | Description | Bits |
|---|---|---|
| Type | Type of Key | 4 |
| | 5 = permanent IO key | |
| | 6 = temporary IO key | |
| Version | Value = 1 | 4 |
| | <reserved> | 4 |
| MCN | Manufacturing Control Number (unique for each | 20 |
| | system) | |
| Days | Number of days that a temporary key can be active | 10 |
| | <reserved> | 22 |
| Expiration | Key expiration (or 0) in Posix time DIV | 16 |
| | (24 * 60 * 60) format | |
| Machine ID | 8 bit WATI machine type + 8 bit type modifier | 16 |
| Unique Key | Key creation Posix time (seconds since Midnight | 32 |
| ID | Jan. 1, 1970); Unique Key ID used to mark use | |
| | and prevent reuse of temporary keys | |
| I/O Rate | System-wide limit I/O rate in KIOs/SEC | 32 |
| I/O Thruput | System-wide limit I/O thruput in MB/SEC | 32 |
| | <reserved> | 32 |
| | <reserved> | 32 |
| Totals | | 256 |

The key type field may be permanent or temporary. Generally, a permanent key has no expiration date whereas a temporary key may have a finite expiration date. Expiration time may be expressed in Posix time format refers to the number of seconds since midnight Jan. 1, 1970. The I/O key may indicate the manufacturing control number (MCN) as well as a machine ID to identify the specific computer system the key was encoded to service. The number of days that a temporary key may be active as well as a key ID are also encoded. The I/O rate field of the I/O key specifies the system-wide I/O limit in kilo I/Os per second. An I/O throughput may also be established with an I/O key by specifying a system-wide limit in megabytes per second.

I/O Resource Distribution

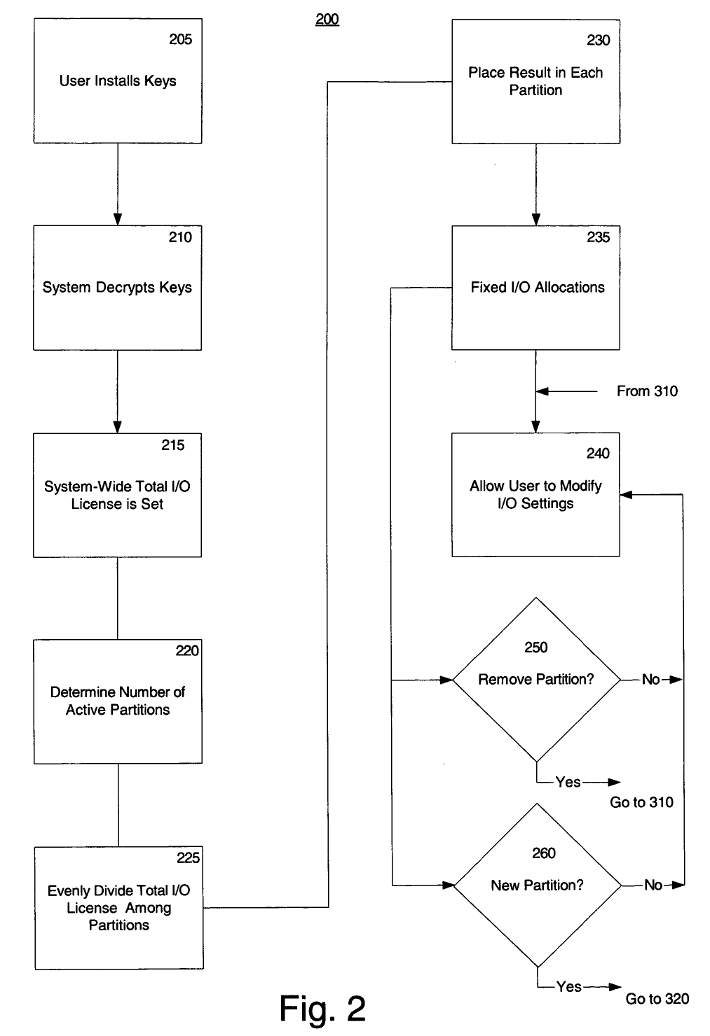

In a system where a processor key has a I/O license bit set and an I/O key is available, the system may have a greater availability of I/O resources. FIG. 2 is a flow diagram 200 depicting the general flow of configuration in a partitioned computer system where an I/O license key is needed. Initially, a user or system administrator installs a processor key having an I/O license bit set so that the system may be configured as an I/O licensed system (step 205). An instruction processor within a partition, running I/O support software (IP1SUPPORT) may decrypt the key (step 210). A system wide total I/O license limit may then be set (step 215) by writing the license limit information into the shared memory of the system control software 96 of the system server 95.

The IP in the active partition then determines the total number of active partitions in the partitioned system (step 220) by accessing shared information in the system control software. Once known, the amount of total I/O license availability is divided by the number of active partitions and a per partition allocation of I/O is determined (step 225). This information is written into the shared memory of the system control software so that other partitions may access it. The active partition may then be enabled and authorized to access the per partition allocation of I/O resources. (step 230). This process results in a fixed resource operating environment (step 235) as long as the number of partitions remains a constant.

In the event that a single partition attempts to exceed the I/O limit, the operating system limits the actual I/O utilized by throttling the IOPs of that partition. For example, if a system has a page or packet size of 4 K bytes, and the I/O limit on the partition is 30K I/Os, then the partition can transfer (4 K bytes×30K I/Os) 120 M bytes per second. The 30K I/O limit is essentially the total number of a packet transfers in the partition where the packet size may be a variable. If the transfer rate of the partition attempted to exceed the 30K I/O per second rate, then the transfers would be stopped for a unit of time until the rate fell below the 30K I/O per second rate. In one embodiment, this throttling of the I/O in a partition is accomplished by the operating system monitoring the total I/Os of a system and controlling the I/O operations on a per partition basis.

From the fixed resource operating position of step 235, a user may alter the I/O resource limits on a partition by accessing the IP within a partition and requesting change in the I/O resource allocation for that partition. In one embodiment, an operator display terminal, connected to one of the I/O channels of an IOP may be used to communicate with the I/O support software running via the operating system (e.g. MCP) in the partition. If the user wishes to reduce the amount of I/O allocated to a partition, then the user may use a user interface command, such as an IOACTIVATE command, and set a specific lower I/O allocation to the partition. If a user wishes the increase the allocation, the I/O support software will check the system wide I/O allocation against the sum of I/O allocation across all partitions to determine if any excess allocation remains. If there is allocation available, then the partition I/O software support may adopt the I/O increase. If there is no unallocated I/O resource available, then the request for additional I/O resources for that partition will be denied.

If additional allocation is denied, yet the user still wishes to add I/O resources to a specific partition, then the user must decide which one or more partitions he wishes to borrow I/O resources from and access those partitions. In one embodiment, each partition is preferably accessed via an operator display terminal associated with an IOP of the partition. Each partition that desirably is to be reduced may be reduced by the user and subsequent I/O operations within that partition will be limited. When a sufficient amount of I/O allocation has been reduced from existing active partitions, then the resources can be reallocated to the partition of interest. For example, in a partitioned computer system where four partitions are operating at 25K I/O each and where the system I/O license limit is 100K I/O, partition number four cannot be increased to 40K I/O because there is no unallocated I/O resources in the system. The user may access any or all of partitions 1-3 and reduce the total allocation of I/O such that 15K I/O is unallocated. The user may then access partition 4 and add in the unallocated 15K I/O to the 4th partition bringing its total of allocation up to 40K I/O.

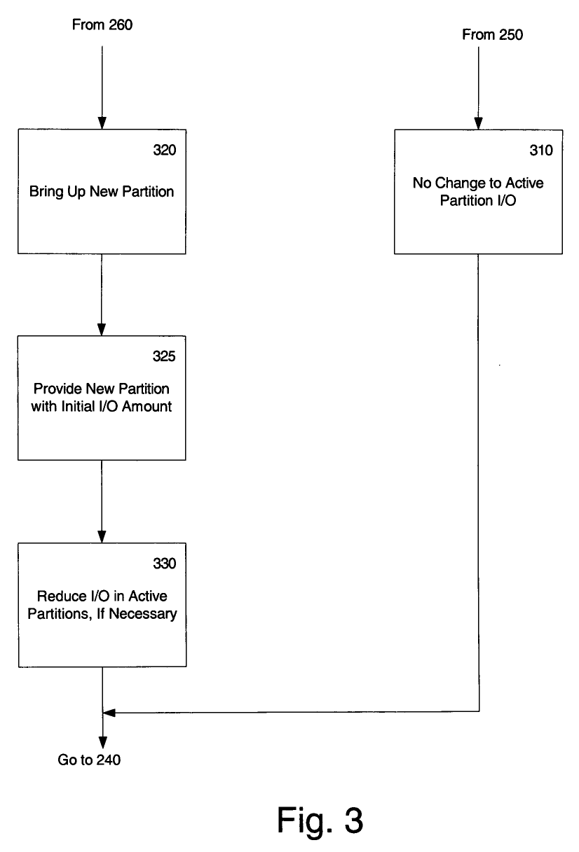

Returning to FIG. 2, if a partition is to be removed (step 250), such as may occur if an active partition having non-zero I/O allocation is taken off line due to operator control or partition failure, the previous allocation for the now-off line partition is now deemed unallocated, but available. In one embodiment, there is no change to the I/O allocation of the still-active partitions (step 310 of FIG. 3). The updated information concerning the number of active partitions and the unallocated I/O resource information is available in the shared memory of the system control software to any active partition.

In the event that a new partition is to be added (step 260 of FIG. 2), the new partition would first be initialized (step 320 of FIG. 3) by bringing up the operating system and the I/O support software. The IP would recognize that the partition is to be a licensed I/O partition and that an I/O key is installed in the system. If the I/O support software determines that there is enough unallocated I/O resource in the system, then the unallocated I/O is made available to the new partition. However, if the I/O in a system has already been allocated leaving no unallocated I/O resource, then an initial amount of I/O resource may be provided to the new partition. However, this creates a violation of the I/O key limit. Consequently, the IPs of the other active partitions are immediately requested to reduce their respective I/O allocations by an amount equal to the initial allocation of the new partition divided by the number of active partitions (step 330). The new partition and the reduced I/O partitions are then subject to operator redistribution of I/O as explained above (step 240 of FIG. 2).

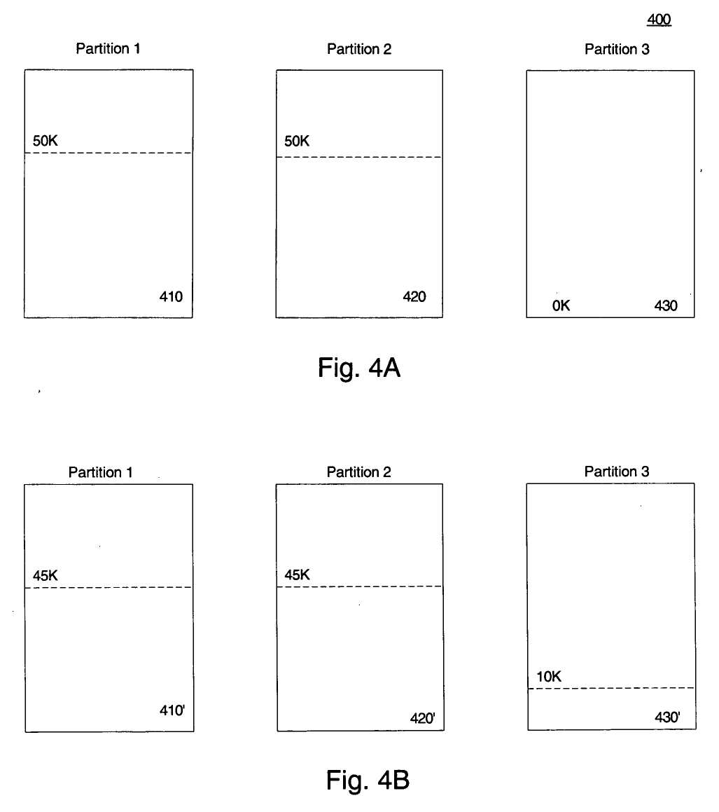

FIGS. 4A and 4B depict the automatic allocation sharing of I/O resources in the event of the introduction of a new partition. Referring to FIG. 4A, assuming a system I/O key total allocation of 100K I/O, the active partitions would be assigned 50K I/O each into partition one 410 and partition two 420. Note that partition three 430 is offline at system initiation and that no allocation was given to partition three. Referring to FIG. 4B, partition three 430′ has been allocated some minimum amount of I/O resource, in this instance, 10K I/O, and as a result, the IP processors of partitions one 410′ and partition two 420′ have reduced 5 K I/O each from their 50K I/O initial allocation to a final 45K I/O to accommodate the new partition three. This is accomplished to stay within the limits of the total I/O key license limitation of 100K for the entire system. Note that at this point, a user may enter the I/O support software in any of the partition and adjust the distribution of I/O for each partition as the partition workload demands. (reference step 240 of FIG. 2.).

In one embodiment, a balance between any two partitions in a partitioned computer system may be performed dynamically. In such an embodiment, a user would initiate an I/O balancing command from one partition specifying another partition to which the balance of I/O allotment is to be shared. The instruction processor (IP) of the first partition may acquire the allocation of the second partition from the shared storage area of the system server and calculate an even distribution between the two partitions. The IP of the first partition may then send commands to the IP of the second partition and both may reallocate I/O resources evenly between the two. For example, if the I/O allocation of partition 5 (40K I/Os) is to be balanced with the I/O allocation of partition 7 (50 K I/Os), the even distribution would be 45 K I/Os. The IP of partition 5 could work with the IP of partition 7 to redistribute the I/O in each partition accordingly. Additionally, if additional allocation were available, say 30K of unallocated I/Os within the system, the redistribution may result in an allocation of 60K I/Os in each of partitions 5 and 7.

User Interface

In one embodiment, a user software interface allows a user to install and manage software keys, including system-wide keys for processor performance, I/O performance, and memory capacity. As an example, the syntax for the interface may be in the form of a set of install keys (IK) commands. The following illustrates an exemplary set of IK command syntax specific to I/O licensing.
IK IOADD <key string>:<password>—installs a single I/O capacity key into Server Control.
IK IOMERGE <keys file>—installs I/O capacity keys from a keys file into Server Control.
IK IODELETE <key ID>—deletes a single I/O capacity key previously installed into Server Control.
IK IOSHOW—displays general I/O capacity licensing information for the system and general key information for all keys installed into Server Control.
IK IOSHOW ALL—displays detailed I/O capacity licensing information for the system and detailed key information for all keys installed into Server Control.
IK IOSHOW <key ID>—displays detailed key information for a specific key installed into Server Control. Key IDs may range from 1 to 999. If the key ID is that of the currently active key, then also detailed I/O licensing and utilization information for the system is also displayed.
IK IOSHOW ACTIVE—displays detailed I/O capacity licensing information for the system and detailed key information for the currently active key.
IK IOACTIVATE <key ID>—activates a specific I/O capacity key. Note, only one I/O capacity performance key may be active system-wide for all partitions. Valid key IDs are available using the IK IOSHOW ALL operator command.
IK IOACTIVATE <num>IOS/SEC—activates a subset of the I/O rate licensed by the currently active I/O capacity key. The command will fail if the I/O rates licensed by the other active partitions plus the I/O rate specified in this command exceeds the total I/O rate licensed in the currently active key.
IK IOACTIVATE <key ID>: <num>IOS/SEC—activates a specific I/O capacity key for the system and a specific I/O rate for the partition. Valid key IDs are available using the IK MEMSHOW ALL operator command.

An exemplary response to an IK IOSHOW ALL command may be displayed as follows:

| | |
|---|---|
| SYSTEM MCN/MACH | 00ABE/0220 PARTITION 1 ACTIVE KEY 5 ALT KEY NONE |
| IO RATE: SYSTEM | 20000 IOS/SEC |
| PARTITION | [1]13000 IOS/SEC [2]7000 IOS/SEC |

| ID | TYPE | STATUS | DAYS/LEFT | EXPIRES | IO RATE |
|---|---|---|---|---|---|
| 5 | PERM | ACTIVE | | | 20000 IOS/SEC |

The display indicates that the system has an MCN/MACH number of 00ABE/0220 and that Partition 1 is being accessed for the information. The I/O rate for the system is 20K I/Os per second divided as 13K I/Os in partition 1 and 7K I/Os in partition 2. The I/O key is key number 5, is active, and is of the permanent type.

As mentioned above, while exemplary embodiments of the invention have been described in connection with various computing devices, the underlying concepts may be applied to any computing device or system in which it is desirable to implement an I/O licensing method. Thus, the methods and systems of the present invention may be applied to a variety of applications and devices. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent systems and methods achieved by the invention.

As is apparent from the above, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., instructions). This program code may be stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer or server, the machine becomes an apparatus for practicing the invention. A computer on which the program code executes will generally include a processor, a storage medium readable by the processor (including volatile and non-volatile memory and/or storage elements), at least one input device, and at least one output device. The program code may be implemented in a high level procedural or object oriented programming language. Alternatively, the program code can be implemented in an assembly or machine language. In any case, the language may be a compiled or interpreted language.

While the present invention has been described in connection with the preferred embodiments of the various figures, it is to be understood that other similar embodiments may be used or modifications and additions may be made to the described embodiment for performing the same function of the present invention without deviating therefrom. Therefore, the invention should not be limited to any single embodiment, but rather should be construed in breadth and scope in accordance with the appended claims.

1. A method of allocating and limiting the amount of input/output (I/O) use in a partition of a computer system, the method comprising:
dividing a system-wide upper limit on I/O usage within a partition of said partitioned computer system by a total number of active partitions within the computer system to establish an allocation quantity of I/O for each partition; and
preventing I/O transfers in a partition from exceeding the allocation quantity for that partition.

2. The method of claim 1, wherein dividing a system-wide upper limit further comprises reading a key and detecting the licensed limit on I/O capacity for the partitioned computer and dividing the system-wide upper limit by a total number of partitions.

3. The method of claim 1, wherein the establishing of an allocation quantity of I/O in each partition comprises setting an operation limit on a quantity of I/O that each partition may use, wherein the operation limit is less than the physical amount of I/O provided in each partition of the computer system.

4. The method of claim 1, wherein preventing I/O transfers in a partition from exceeding the allocation quantity for that partition comprises counting I/O transfers across one or more I/O channels in a partition and stopping further I/O transfers which exceed the allocation quantity for the partition.

5. A method of adding input/output (I/O) capacity to a newly activated partition in a partitioned computer system, the method comprising:
determining a first fixed amount of I/O to be added to the newly activated partition;
determining a number of active computer partitions that are currently allocated an amount of I/O;
dividing the first fixed amount by the number of active computer partitions to calculate a reduction amount;
reducing an amount of I/O in every partition by the reduction amount; and
adding the first fixed amount of I/O to the newly activated partition; whereby the new partition receives an allocation from the active partitions.

6. A method of allocating input/output (I/O) usage in a partitioned computer system, the method comprising:
establishing a system-wide limit for I/O usage; and
activating a portion of the system-wide I/O limit for use in each computer partition, wherein the activation is performed via an object library that manages licensing to verify activations;
allowing a computer partition to utilize the activated portion of I/O; and
measuring I/O utilization and limiting I/O use on a partition level to meet the system-wide limit.

7. The method of claim 6, wherein the step of activating a portion of the system-wide I/O limit comprises using an I/O key, wherein the I/O key provides a specific license.

8. The method of claim 6, wherein the step of activating comprises using an amount of I/O that is equal to or less than the amount of system-wide I/O minus the amount of actively used I/O resources.

9. A method of balancing input/output allocation between two computer partitions in a computer system, the method comprising:
accessing from a first partition, a current I/O allocation of a second partition;
adding a current I/O allocation of the first partition to the current allocation of the second partition to find a combined allocation;
dividing the combined allocation evenly between the first and second partitions and communicating the divided allocation to the first and second allocations; and
establishing the divided allocation as a new I/O limit within the first and the second computer partitions.

10. The method of claim 9, further comprising:
detecting an unallocated portion of I/O resource available within the computer system;
distributing the unallocated portion of I/O resource evenly between the first partition and the second partition.

11. A computer-readable medium having stored thereon a data structure for an input/output (I/O) resource key, the data structure comprising:
a first data field containing identification information wherein the identification information identifies a computer system;
a second data field containing an I/O rate for the computer system; and
a third data field containing an I/O key identifier;
wherein the I/O resource key is used to enable the use of I/O resources within at least one partition in the computer system.

12. The data structure of claim 11, further comprising a fourth data field comprising an expiration date for the I/O resource key.

13. A computer system comprising:
at least one partition, each partition having at least one processor and associated memory;
at least one data structure having an identification field and an input/output (I/O) resource field;
executable software which interprets the at least one data structure and enable the at least one partition to access an I/O resource; and
a user interface which allows modification of the I/O resource within the computer system.

14. The system of claim 13, wherein the at least one data structure comprises one or more of an I/O key and a processor key.

15. The system of claim 13, wherein the at least one data structure further comprises an I/O allocation for the computer system.

16. A computer-readable medium having instructions therein, executable by a computer having at least one partition to perform the method of allocating and limiting the amount of input/output (I/O) use in a partition of a computer system, the method comprising:
dividing a system-wide upper limit on I/O usage within the partitioned computer by a total number of active partitions within the computer system to establish an allocation quantity of I/O for each partition; and
preventing I/O transfers in a partition from exceeding the allocation quantity for that partition.

17. The computer-readable medium of claim 16, wherein dividing further comprises reading a key and detecting the licensed limit on I/O capacity for the partitioned computer and dividing the system-wide upper limit by a total number of partitions.

18. The computer-readable medium of claim 16, wherein preventing I/O transfers in a partition from exceeding the allocation quantity for that partition comprises counting I/O transfers across one or more I/O channels in a partition and stopping further I/O transfers which exceed the allocation quantity for the partition.

19. A computer-readable medium having instructions therein, executable by a computer having at least one partition to perform the method of adding input/output (I/O) capacity to a newly activated partition in a partitioned computer system, the method comprising:
determining a first fixed amount of I/O to be added to the newly activated partition;
determining a number of active computer partitions that are currently allocated an amount of I/O;
dividing the first fixed amount by the number of active computer partitions to calculate a reduction amount;
reducing an amount of I/O in every partition by the reduction amount; and
adding the first fixed amount of I/O to the newly activated partition; whereby the new partition receives an allocation from the active partitions.

20. A computer-readable medium having instructions therein, executable by a computer having at least one partition to perform the method of allocating input/output (I/O) usage in a partitioned computer system, the method comprising:
establishing a system-wide limit for I/O usage; and
activating a portion of the system-wide I/O limit for use in each computer partition, wherein the activation is performed via an object library that manages licensing to verify activations;
allowing a computer partition to utilize the activated portion of I/O; and
measuring I/O utilization and limiting I/O use on a partition level to meet the system-wide limit.

21. The computer-readable medium of claim 20, wherein the step of activating a portion of the system-wide I/O limit comprises using an I/O key, wherein the I/O key provides a specific license.

22. A computer-readable medium having instructions therein, executable by a computer having at least one partition to perform the method of balancing input/output allocation between two computer partitions in a computer system, the method comprising:
accessing from a first partition, a current I/O allocation of a second partition;
adding a current I/O allocation of the first partition to the current allocation of the second partition to find a combined allocation;
dividing the combined allocation evenly between the first and second partitions and communicating the divided allocation to the first and second allocations; and
establishing the divided allocation as a new I/O limit within the first and the second computer partitions.

23. The computer-readable medium of claim 22, further comprising:
detecting an unallocated portion of I/O resource available within the computer system;
distributing the unallocated portion of I/O resource evenly between the first partition and the second partition.
